(19) United States
(12) Patent Application Publication
(10) Pub. No.: US 2025/0240526 A1
(43) Pub. Date: Jul. 24, 2025

(54) PREDICTIVE ELECTRONIC IMAGE STABILIZATION (EIS)

(71) Applicant: QUALCOMM Incorporated, San Diego, CA (US)

(72) Inventors: Nitin Bandwar, San Diego, CA (US); Thomas Patrick Carr, Cork (IE); Ron Gaizman, Hof HaCarmel (IL); Tauseef Kazi, San Diego, CA (US); Wesley Elizaga Jonson, San Diego, CA (US)

(21) Appl. No.: 18/421,789

(22) Filed: Jan. 24, 2024

(51) Int. Cl. H04N 23/68

(52) U.S. Cl. CPC H04N 23/6812; H04N 23/6811

(57) ABSTRACT

An apparatus includes a processing system including one or more processors and one or more memories coupled to the one or more processors. The processing system is configured to receive first data from an image sensor and to receive second data from one or more motion sensors. The second data is associated with a first state of the one or more motion sensors. The processing system is further configured to determine, based on the second data, a prediction of a second state of the one or more motion sensors and to perform electronic image stabilization (EIS) associated with the first data based on the prediction of the second state.

### TECHNICAL FIELD

Aspects of the disclosure relate generally to image processing, and more particularly, to electronic image stabilization (EIS) in image processing.

### INTRODUCTION

Video recording has become an important aspect of electronic devices equipped with cameras, such as smart phones, point-and-shoot cameras, digital video recorders, surveillance cameras, and other devices. Some such devices may be subject to shake and jitter due to user movement as well as other external factors (such as movement caused by recording in a moving car or while walking), which may reduce quality of captured video.

Image stabilization may be used to compensate for such effects. Image stabilization techniques include optical image stabilization (OIS), digital image stabilization (DIS), electronic image stabilization (EIS), and other techniques. EIS techniques may involve estimating an amount of movement and compensating video data based on the estimated amount of movement. EIS techniques may dynamically select a subset frame area from a larger frame area based on data from the one or more motion sensors in order to compensate for device motion.

The difference between the subset frame area and the larger frame area may be referred to as a spatial margin area. Video data in the spatial margin area may be trimmed and deleted by a device. However, captured video data in the spatial margin area may still be subject to one or more operations prior to being trimmed, such as by being transferred to and from image processing components and by being stored to and retrieved from one or more memories. Such operations may consume power and may use device resources (such as processing resources, storage resources, and device bandwidth) without contributing to the resulting stabilized video.

### BRIEF SUMMARY OF SOME EXAMPLES

In some aspects of the disclosure, an apparatus includes a processing system including one or more processors and one or more memories coupled to the one or more processors. The processing system is configured to receive first data from an image sensor and to receive second data from one or more motion sensors. The second data is associated with a first state of the one or more motion sensors. The processing system is further configured to determine, based on the second data, a prediction of a second state of the one or more motion sensors and to perform electronic image stabilization (EIS) associated with the first data based on the prediction of the second state.

In some other aspects, a method of operation of a device includes receiving first data from an image sensor of the device and receiving second data from one or more motion sensors of the device. The second data is associated with a first state of the one or more motion sensors. The method further includes determining, based on the second data, a prediction of a second state of the one or more motion sensors and performing electronic image stabilization (EIS) associated with the first data based on the prediction of the second state.

In some additional aspects, a non-transitory computer-readable medium stores instructions executable by a processor to perform operations. The operations include receiving first data from an image sensor and receiving second data from one or more motion sensors. The second data is associated with a first state of the one or more motion sensors. The operations further include determining, based on the second data, a prediction of a second state of the one or more motion sensors and performing electronic image stabilization (EIS) associated with the first data based on the prediction of the second state.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a block diagram of an example of a device that supports predictive electronic image stabilization (EIS) according to one or more aspects.

FIG. 2 is a block diagram illustrating examples of margins that may be associated with predictive EIS according to one or more aspects.

FIG. 3 illustrates an example of an image signal processor (ISP) that supports predictive EIS according to one or more aspects.

FIG. 4 illustrates an example of a state transition diagram that supports predictive EIS according to one or more aspects.

FIG. 5 illustrates an example of a process that supports predictive EIS according to one or more aspects.

FIG. 6 illustrates another example of a process that supports predictive EIS according to one or more aspects.

FIG. 7 illustrates another example of a process that supports predictive EIS according to one or more aspects.

FIG. 8 illustrates another example of a process that supports predictive EIS according to one or more aspects.

Like reference numbers and designations in the various drawings indicate like elements.

### DETAILED DESCRIPTION

In some aspects of the disclosure, a device may receive data from one or more sensors and may use the data to estimate motion associated with the device (also referred to herein as classifying the motion). The device may adaptively modify spatial margin area for electronic image stabilization (EIS) based on the estimated motion. In some examples, the estimated motion of the device may relate to an activity of a user associated with the device. To illustrate, low or zero estimated motion may be associated with a first spatial margin area, walking may be associated with a second spatial margin area greater than the first spatial margin area, and running may be associated with a third spatial margin area greater than the second spatial margin area.

In some examples, the data may include gyroscopic data. Alternatively, or in addition, the device may use other data to estimate motion, such as focal length data, optical image stabilization (OIS) data, bounding box information, or other data. In some implementations, the data may be input to a machine learning (ML) engine that may estimate the motion.

In some examples, the ML engine may refine (or “smooth”) data values representing the estimated motion to increase quality or accuracy of estimation. For example, data values associated with different timestamps may be used to create a weighted prediction. In some implementations, data input to the ML engine may be transformed via a discrete cosine transform (DCT) and may be inversely transformed via an inverse DCT, which may simplify certain operations of the ML engine.

By dynamically changing spatial margin area based on estimated motion associated with a device, the device may predictively increase spatial margin area if activities associated with increased shake or jitter (such as running) are predicted to occur while also decreasing spatial margin area if activities associated with less shake or jitter (such as sitting or standing) are predicted to occur. As a result, video content may benefit from increased stabilization during some activities while reducing an amount of unused video data during other activities, which may reduce power consumption and device resource utilization (e.g., utilization of processing resources, memory resources, and bandwidth).

To illustrate, in some examples, one or more features described herein may reduce power consumption and may also reduce an amount of data transferred among device components, such as components of an image signal processor, one or more memories, one or more other components, or a combination thereof. For example, a margin area associated with EIS may be determined sooner as compared to other techniques (such as a non-predictive technique), which may be associated with increased lag. As a result, one or more portions of video data may be deleted (e.g., by invalidating, erasing, or overwriting such portions at one or more memories) sooner as compared to other techniques, such as a non-predictive technique. As a non-limiting example, in some implementations, such portions may be deleted at a front end stage of an image signal processor (ISP) instead of at a subsequent stage of the ISP, such as an engine for video analytics (EVA) stage or an image post-processing engine (IPE) stage. Accordingly, power consumption associated with transfer and storage of such video data may be reduced while also reducing use of device resources, such as processing resources, storage resources, and device bandwidth.

Some portions of the detailed descriptions may be presented in terms of procedures, logic blocks, processing, and other symbolic representations of operations on data bits within a computer memory. In the present disclosure, a procedure, logic block, process, or the like, may be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device for capturing image frames using one or more image sensors, such as a smartphone, may include a configuration of one, two, three, four, or more camera modules on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames (such as through a bus) in a memory and/or provide the output image frames to processing circuitry (such as an applications processor). The processing circuitry may perform further processing, such as for encoding, storage, transmission, or other manipulation of the output image frames.

As used herein, a camera module may include the image sensor and certain other components coupled to the image sensor used to obtain a representation of a scene in image data comprising an image frame. For example, a camera module may include other components of a camera, including a shutter, buffer, or other readout circuitry for accessing individual pixels of an image sensor. In some embodiments, the camera module may include one or more components including the image sensor included in a single package with an interface configured to couple the camera module to an image signal processor or other processor through a bus.

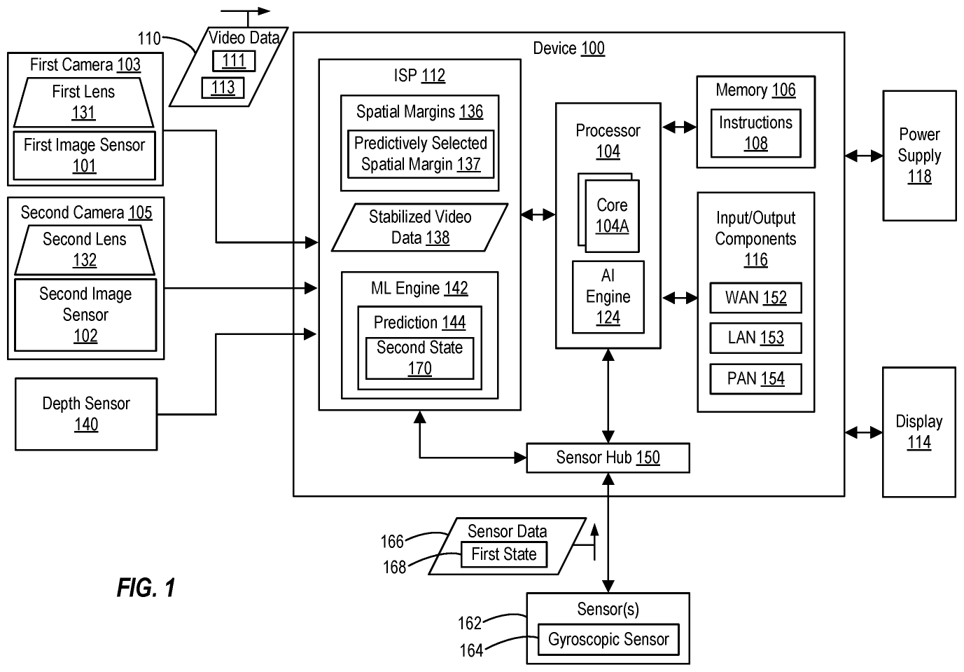

FIG. 1 is a block diagram of an example of a device 100 that supports predictive electronic image stabilization (EIS) according to one or more aspects. The device 100 may include, or otherwise be coupled to, an image signal processor (ISP), such as ISP 112, for processing image frames from one or more image sensors, such as a first image sensor 101, a second image sensor 102, and a depth sensor 140. In some implementations, the device 100 also includes or is coupled to a processor 104 and a memory 106 storing instructions 108 (e.g., a memory storing processor-readable code or a non-transitory computer-readable medium storing instructions). The device 100 may also include or be coupled to a display 114 and components 116. Components 116 may be used for interacting with a user, such as a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device 100 may include or be coupled to a sensor hub 150 for interfacing with sensors to receive data regarding movement of the device 100, data regarding an environment around the device 100, and/or other non-camera sensor data. One example non-camera sensor is a gyroscopic sensor, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscopic sensor in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one embodiment, a local bus connection couples the ISP 112 to the first image sensor 101 and second image sensor 102 of a first camera 103 and second camera 105, respectively. In another embodiment, a wire interface couples the ISP 112 to an external image sensor. In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data. The digital image data may be formatted as one or more image frames, whether received from the first camera 103 and/or second camera 105 or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated an autofocus (AF) engine executing in the ISP 112, which adjusts the first lens 131 and the second lens 132 to focus on a particular focal plane located at a certain scene depth. The AF engine may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

Each of the first camera 103 and second camera 105 may be configured through hardware configuration and/or software settings to obtain different, but overlapping, field of views. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A variable aperture (VA) camera may have different characteristics that produced different representations of a scene based on a current aperture size. For example, a VA camera may capture image data with a depth of focus (DOF) corresponding to a current aperture size set for the VA camera.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mmWave, radio detection and ranging (Radar), and/or hybrid depth sensors, such as structured light sensors. In embodiments without a depth sensor 140, similar information regarding depth of objects or a depth map may be determined from the disparity between first camera 103 and second camera 105, such as by using a depth-from-disparity procedure, a depth-from-stereo procedure, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include specific hardware (such as one or more integrated circuits (ICs)) configured to perform one or more operations described in the present disclosure. For example, the ISP 112 may include one or more of an image front end (IFE), an image post-processing engine (IPE), an auto exposure compensation (AEC) engine, or an engine for video analytics (EVA). An image pipeline may be formed by a sequence of one or more of the IFE, the IPE, or the EVA. In some embodiments, the image pipeline may be reconfigurable in the ISP 112 by changing connections between the IFE, the IPE, and/or the EVA. The AF engine, the AEC engine, the IFE, the IPE, and the EVA may each include application-specific circuitry, software or firmware executed by the ISP 112, and/or a combination of hardware and software or firmware executing on the ISP 112.

The memory 106 may include a non-transient or non-transitory computer readable medium storing computer-executable instructions as instructions 108 to perform all or a portion of one or more operations described in this disclosure. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or second camera 105 and the ISP 112.

In addition to instructions 108, the memory 106 may also store image frames. The image frames may be output image frames stored by the ISP 112. The output image frames may be accessed by the processor 104 for further operations. In some embodiments, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some embodiments, the device 100 is a system-on-chip (SoC) that incorporates the ISP 112, the processor 104, the sensor hub 150, the memory 106, and/or components 116 into a single package.

In some aspects, at least one of the ISP 112 or the processor 104 executes instructions to perform various operations described herein. For example, execution of the instructions can instruct the ISP 112 to begin or end capturing an image frame or a sequence of image frames. In some embodiments, the processor 104 may include one or more cores 104A-N capable of executing instructions to control operation of the ISP 112. For example, the cores 104A-N may execute a camera application (or other suitable application for generating images or video) stored in the memory 106 to activate or deactivate the ISP 112 for capturing image frames and/or to control the ISP 112 in processing the image frames. The operations of the cores 104A-N and ISP 112 may be based on user input. For example, a camera application executing on processor 104 may receive a user command to begin a video preview display upon which a video comprising a sequence of image frames is captured and processed from first camera 103 and/or the second camera 105 through the ISP 112 for display and/or storage. Image processing to determine “output” or “corrected” image frames, such as according to techniques described herein, may be applied to one or more image frames in the sequence.

In some embodiments, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, face detection and/or object recognition performed using machine learning (ML) or artificial intelligence (AI). The AI engine 124 may be referred to as an artificial intelligence processing unit (AIPU). The AI engine 124 may include hardware configured to perform and accelerate convolution operations involved in machine learning, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training. In some other embodiments, the device 100 does not include the processor 104, such as when all of the described functionality is configured in the ISP 112.

In some embodiments, the display 114 may include one or more suitable displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

In some examples, the ISP 112 may include a machine learning (ML) engine 142. FIG. 1 also illustrates that the device 100 may include, or may be coupled to (e.g., via the sensor hub 150), one or more sensors 162. In some implementations, the one or more sensors 162 may include one or more motion sensors that detect motion of the device 100, one or more position sensors that detect position of the device 100, one or more orientation sensors that detect orientation of the device 100, one or more other sensors, or a combination thereof. In the example of FIG. 1, the one or more sensors 162 may include a gyroscopic sensor 164. The gyroscopic sensor 164 may include, for example, one or more of a gyroscope, an inertial measurement unit (IMU) device, or another sensor.

During operation, the device 100 may initiate capture of first data, such as video data 110. For example, one or more of the ISP 112 or the processor 104 may instruct one or both of the first camera 103 or the second camera 105 to capture the video data 110. The ISP 112 may receive the video data (e.g., from one or more of the first camera 103 or the second camera 105). In some examples, the video data 110 may include or may be associated with depth data generated by the depth sensor 140.

In some examples, the ISP 112 may perform EIS based on the video data 110 to improve stability associated with the video data 110. For example, if a user of the device 100 is walking, running, or otherwise moving, video content generated based on the video data 110 may appear shaky or destabilized. In another example, if the user is aboard a vehicle (such as a car, truck, boat, train, or aircraft), movement of the vehicle may cause the video content to appear shaky or destabilized. Such types of movement are referred to herein as movement associated with the device 100.

In some examples, the ISP 112 may stabilize the video data 110 to generate stabilized video data 138. For example, the ISP 112 may receive the video data 110 and may identify, for at least one frame of the video data 110, a predictively selected spatial margin 137 from among spatial margins 136.

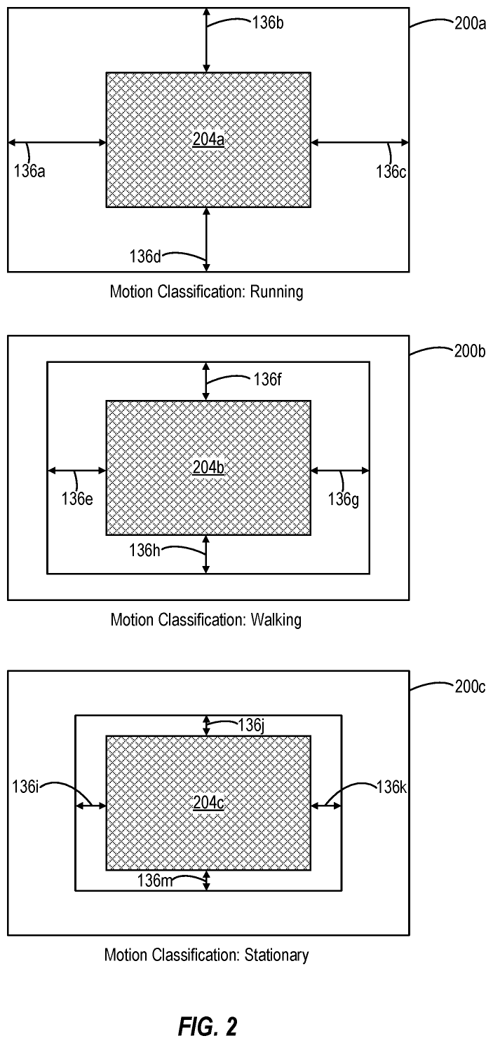

To further illustrate, FIG. 2 is a block diagram illustrating examples of margins that may be associated with predictive EIS according to one or more aspects. In the example of FIG. 2, the margins may be described with reference to a frame 200a, a frame 200b, and a frame 200c. The frames 200a-c may be included in the video data 110 of FIG. 1.

In some examples, the frame 200a may be stabilized based on a left vertical spatial margin 136a, a top horizontal spatial margin 136b, a right vertical spatial margin 136c, and a bottom horizontal spatial margin 136d to produce a stabilized frame 204a (e.g., a frame included in the stabilized video data 138). In some implementations, the margins 136a-d may be associated with eighty percent of the frame 200a. In such examples, the margins 136a-d may be referred to as a twenty percent margin area. Further, in such examples, the predictively selected spatial margin 137 of FIG. 1 may correspond to twenty percent.

In some examples, the frame 200b may be stabilized based on a left vertical spatial margin 136e, a top horizontal spatial margin 136f, a right vertical spatial margin 136g, and a bottom horizontal spatial margin 136h to produce a stabilized frame 204b (e.g., a frame included in the stabilized video data 138). In some implementations, the margins 136e-h may be associated with ninety percent of the frame 200b. In such examples, the margins 136e-h may be referred to as a ten percent margin area. Further, in such examples, the predictively selected spatial margin 137 of FIG. 1 may correspond to ten percent.

In some examples, the frame 200c may be stabilized based on a left vertical spatial margin 136i, a top horizontal spatial margin 136j, a right vertical spatial margin 136k, and a bottom horizontal spatial margin 136m to produce a stabilized frame 204c (e.g., a frame included in the stabilized video data 138). In some implementations, the margins 136i-m may be associated with five percent of the frame 200c. In such examples, the margins 136i-m may be referred to as a ninety-five percent margin area. Further, in such examples, the predictively selected spatial margin 137 of FIG. 1 may correspond to five percent.

In some aspects of the disclosure, EIS may be performed in multiple “passes” using multiple different margins. For example, referring to the frame 204b, a first stage of the device 100 may perform a first crop (e.g., a “coarse” crop) based on the margins 136a-d, and a second stage of the device 100 may perform a second crop (e.g., a “fine” crop) based on the margins 136e-h. As another example, referring to the frame 204c, the first stage may perform a first crop (e.g., a “coarse” crop) based on the margins 136a-d, and a second stage of the device 100 may perform a second crop (e.g., a “fine” crop) based on the margins 136i-m. In some examples, the first stage may correspond to a first IFE stage, a second IFE stage, or an image sensor output stage of the device 100, and the second stage may correspond to an IPE stage of the device 100. Other examples are also within the scope of the disclosure.

FIG. 2 also illustrates that margin area may be selected based on an estimated motion (also referred to herein as a motion classification). In some examples, the estimated motion of the device may relate to or may be based on a user activity. To illustrate, in some examples, the spatial margins 136a-d may be selected based on determining that the motion classification corresponds to a running user activity. In some other examples, the spatial margins 136e-h may be selected based on determining that the motion classification corresponds to a walking user activity. In some further examples, the spatial margins 136i-m may be selected based on determining that the motion classification corresponds to a stationary user activity. Other examples are also within the scope of the disclosure. For example, alternatively or in addition to motion related to user activity, the device 100 may experience motion that is unrelated to user activity, such as if the device 100 corresponds to a drone or autonomous vehicle that may initiate motion unrelated to user activity.

Referring again to FIG. 1, the one or more sensors 162 may generate sensor data 166. In some examples, the gyroscopic sensor 164 may generate the sensor data 166, and the sensor data 166 may indicate or may be associated with a first state 168 of the gyroscopic sensor 164. For example, the first state 168 may specify a first position of the gyroscopic sensor 164, such as a first set of x, y, and z coordinate values. Further, in some examples, the depth sensor 140 may be included in the one or more sensors 162, and the sensor data 166 may include depth data generated by the depth sensor 140.

The device 100 may input the sensor data 166 to the ML engine 142. For example, in some implementations, the device 100 may receive at least some of the sensor data 166 at the sensor hub 150 and may use the sensor hub to provide at least some of the sensor data 166 to the ISP 112, which may input the sensor data 166 to the ML engine 142.

The ML engine 142 may generate a prediction 144 based on the sensor data 166. In some examples, the prediction 144 may indicate a second state 170 associated with the gyroscopic sensor 164. For example, the second state 170 may specify a second position of the gyroscopic sensor 164 different than the first position, such as a second set of x, y, and z coordinate values different than the first set of x, y, and z coordinate values.

To further illustrate, the first state 168 may be associated with a first timestamp corresponding to a first time instant, and the prediction 144 may be associated with at least a second timestamp corresponding to a second time instant, where the second time instant is a particular time period after the first time instant. The ML engine 142 may determine, prior to the second time instant, that the gyroscopic sensor 164 is likely to be in the second position at the second time instant.

In some examples, the video data 110 may include first image data 111 captured at a first time and may further include second image data 113 captured at a second time after the first time. In an example, the first image data 111 may include the frame 200a of FIG. 2, and the second image data 113 may include the frame 200b or the frame 200c of FIG. 2. In another example, the first image data 111 may include the frame 200a or 200b of FIG. 2, and the second image data 113 may include the frame 200c of FIG. 2.

The device 100 may process the first image data 111 (e.g., by performing EIS associated with the first image data 111) according to a first spatial margin and according to the first state 168. The device 100 may process the second image data 113 (e.g., by performing EIS associated with the second image data 113) according to a second spatial margin different than the first spatial margin and according to the prediction 144 of the second state 170. In some examples, the first spatial margin may correspond to one of the spatial margins described with reference to FIG. 2, and the second spatial margin may correspond to another of the spatial margins described with reference to FIG. 2. Further, the second spatial margin may correspond to, or may be referred to as, the predictively selected spatial margin 137.

The ISP 112 may identify the predictively selected spatial margin 137 from among the spatial margins 136 based on the prediction 144 of the second state 170. Based on the predictively selected spatial margin 137, the ISP 112 may generate the stabilized video data 138, such as by cropping one or more of the frames 200a-c to generate one or more of the stabilized frames 204a-c, as illustrated in the example of FIG. 2. The stabilized video data 138 may include one or more of the stabilized frames 204a, 204b, and 204c of FIG. 2.

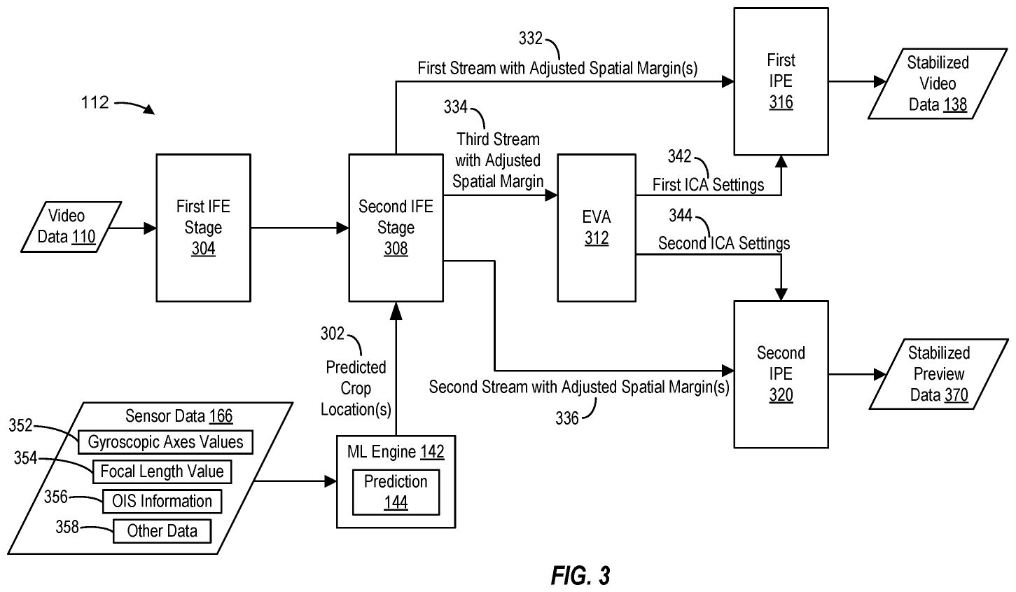

In some examples, the ISP 112 may output the stabilized video data 138, such as to the processor 104. Alternatively, or in addition, the stabilized video data 138 may be stored to the memory 106, transmitted to one or more other devices (e.g., via the components 116), or a combination thereof. Alternatively, or in addition, an image preview associated with the stabilized video data 138 may be presented (e.g., via the display 114), as described further with reference to FIG. 3.

FIG. 3 illustrates an example of an ISP 112 that supports predictive EIS according to one or more aspects. In the example of FIG. 3, the ISP 112 may include one or more of the ML engine 142, a first image front end (IFE) stage 304, a second IFE stage 308, an engine for video analytics (EVA) 312, a first image post-processing engine (IPE) 316, or a second IPE 320. The first IFE stage 304 may be coupled to the second IFE stage 308. The second IFE stage 308 may be coupled to the ML engine 142, to the EVA 312, to the first IPE 316, and to the second IPE 320. The EVA 312 may be coupled to the second IFE stage 308, to the first IPE 316, and to the second IPE 320. The first IPE 316 may be coupled to the second IFE stage 308 and to the EVA 312. The second IPE 320 may be coupled to the second IFE stage 308 and to the EVA 312.

During operation, the ML engine 142 may receive the sensor data 166. FIG. 3 illustrates that the sensor data 166 may include one or more of gyroscopic axes values 352 that may be associated with the gyroscopic sensor 164, a focal length value 354 (e.g., a focal length of the first camera 103 or the second camera 105 at a time of capturing one or more frames of the video data 110), optical image stabilization (OIS) information 356, or other data 358. In some examples, any of the gyroscopic axes values 352, the focal length value 354 the OIS information 356, or the other data 358 (such as bounding box information or other information). In some examples, the gyroscopic axes values 352 correspond to or represent the first state 168 of FIG. 1.

The ML engine 142 may generate the prediction 144 of the second state 170, such as in accordance with one or more examples described herein. The ML engine 142 may determine one or more predicted crop locations 302 based on the prediction 144. For example, based on the prediction 144 of the second state 170, the ML engine 142 may predict a field of view of one or more of the first camera 103 or the second camera 105. Based on the predicted field of view, the ML engine 142 may determine the one or more predicted crop locations 302 (e.g., to increase stability across frames of video data). In an example, the one or more predicted crop locations 302 may correspond to a boundary between a frame of the stabilized frames 204a-c and the remainder of the frame.

The ML engine 142 may provide an indication of the one or more predicted crop locations 302 to the second IFE stage 308. The second IFE stage 308 may generate, based on the one or more predicted crop locations 302, a first stream 332, a second stream 336, and a third stream 334 (e.g., a downscaled stream). In some examples, the first stream 332 may be associated with a first resolution, and the second stream 336 may be associated with a second resolution that is less than the first resolution. The second IFE stage 308 may provide the first stream 332 to the first IPE 316, the third stream 334 to the EVA 312, and the second stream 336 to the second IPE 320.

In some examples, one or more of the first stream 332, the second stream 336, or the third stream 334 may be associated with the predictively selected spatial margin 137 of FIG. 1. For example, the second IFE stage 308 may predictively select margins associated with one or more of the first stream 332, the second stream 336, or the third stream 334 based on the one or more predicted crop locations 302.

The EVA 312 may generate, based on the third stream 334, first independent component analysis (ICA) settings 342 and second ICA settings 344. The EVA 312 may provide the first ICA settings 342 to the first IPE 316 and provide the second ICA settings 344 to the second IPE 320. Based on the first stream 332 and the first ICA settings 342, the first IPE 316 may generate the stabilized video data 138. Based on the second stream 336 and the second ICA settings 344, the second IPE 320 may generate stabilized preview data 370. The stabilized preview data 370 may correspond to a preview version of the stabilized video data 138 that may be presented via the display 114.

In some examples, the stabilized video data 138 may be associated with a first resolution, and the stabilized preview data 370 may be associated with a second resolution that is less than the first resolution. As an illustrative example, in some implementations, the stabilized video data 138 may be associated with an ultra-high definition (UHD) format, and the stabilized preview data 370 may be associated with a full-high definition (FHD) format. Other examples are also within the scope of the disclosure.

The example of FIG. 3 illustrates that predictive EIS may improve performance by enabling portions of video data to be deleted sooner in a processing pipeline of the ISP 112 as compared to certain other techniques. As a non-limiting example, in some implementations, data may be trimmed at a first stage of the ISP 112 (e.g., at the second IFE stage 308 or another stage) instead of at a second stage subsequent to the first stage of the ISP 112. In some examples, the first stage may correspond to the second IFE stage 308, and the second stage may correspond to one or more of the EVA 312, the first IPE 316, or the second IPE 320. In some other examples, the first stage may correspond to an image sensor output stage, such as an image sensor output stage of the first image sensor 101 or the second image sensor 102. As a result, one or more portions of the video data 110 may be deleted (e.g., by invalidating, erasing, or overwriting such portions) sooner as compared to other techniques, such as a non-predictive technique, reducing power consumption and resource usage of the ISP 112.

In addition, in some examples, predictive EIS may be performed in multiple “passes” or multiple stages, such as in connection with a coarse-and-fine adjustment of spatial margin. To illustrate, in some examples, a first stage of the ISP 112 may perform coarse spatial margin adjustment, and a second stage of the ISP 112 following the first stage may perform fine spatial margin adjustment (e.g., to refine the coarse spatial margin adjustment). In some examples, the first stage may correspond to an input of the second IFE stage 308, and the second stage may correspond to a portion of the second IFE stage 308 following the input. In some other examples, the second stage may correspond to the EVA 312, the first IPE 316, or the second IPE 320. In some implementations, the first stage may pad a margin area or a subset of a margin area (e.g., with zero values or other values) to enable more accurate adjustment by the second stage. To further illustrate, in an example of a multi-stage operation, the ISP 112 may perform a first crop (e.g., at the first IFE stage 304) of the video data 110 and may perform a second crop (e.g., at the second IFE stage 308) of the video data 110 after the first crop. In some examples, the first crop may correspond to a “coarse” crop that uses a first margin, and the second crop may correspond to a “fine” crop that uses a second margin greater than the first margin. In some examples, the first margin may correspond to ten percent (or another value), and the second crop may correspond to five percent (or another value). Further, in some examples, the first crop may be performed based on a prediction (such as the prediction 144), and the second crop may be performed based on a sensor data value (such as an actual data value of the sensor data 166).

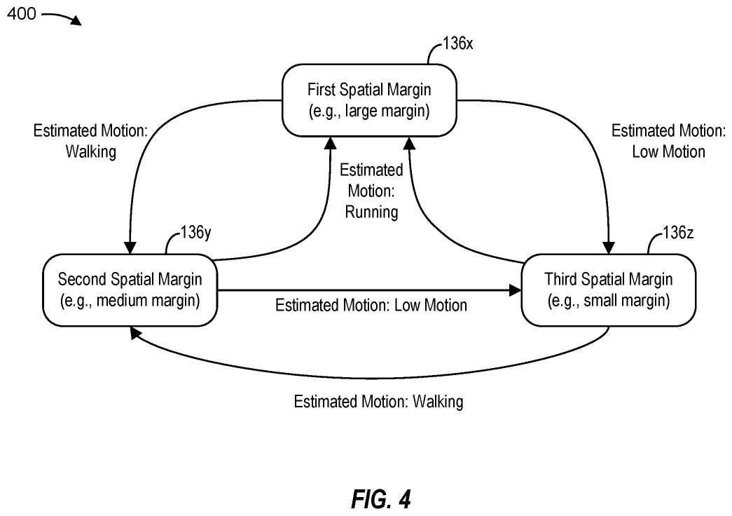

In some implementations, the ISP 112 may adjust one or more spatial margins based on an estimated motion, which may be determined by the ML engine 142. Some such examples are described further with reference to FIG. 4.

FIG. 4 illustrates an example of a state transition diagram 400 that supports predictive EIS according to one or more aspects. In the example of FIG. 4, the state transition diagram 400 may be associated with a plurality of motion classifications associated with the device 100. In some examples, the plurality of motion classifications may relate to or may be based on a plurality of activity types, such as walking, running, and low motion, which may include, for example, no motion or placement of the device 100 on a tripod or other structure.

Each activity type of the plurality of activity types may be associated with a respective spatial margin of a plurality of spatial margins. For example, running may be associated with a first spatial margin 136x, walking may be associated with a second spatial margin 136y, and low motion may be associated with a third spatial margin 136z. In some examples, the first spatial margin 136x is greater than the second spatial margin 136y, and the second spatial margin 136y is greater than the third spatial margin 136z. As a non-limiting, illustrative example, the first spatial margin 136x may correspond to twenty percent, the second spatial margin 136y may correspond to ten percent, and the third spatial margin 136z may correspond to five percent. Other examples are also within the scope of the disclosure. In some examples, the spatial margins 136x-z may be included in the spatial margins 136 of FIG. 1.

During operation, the device 100 of FIG. 1 may monitor the sensor data 166 to predict state transitions associated with the state transition diagram 400. Based on a predicted state transmission, the device 100 may adjust among the spatial margins used for EIS of the video data 110 to generate the stabilized video data 138.

To illustrate, if the prediction 144 of the second state 170 indicates that a user of the device 100 is likely to transition from a running activity to a walking activity or to a low motion activity, then the device 100 may adjust from using the first spatial margin 136x to using the second spatial margin 136y or to the third spatial margin 136z, respectively. As another example, if the prediction 144 of the second state 170 indicates that a user of the device 100 is likely to transition from a walking activity to a running activity or to a low motion activity, then the device 100 may adjust from using the second spatial margin 136y to using the first spatial margin 136x or to the third spatial margin 136z, respectively. As an additional example, if the prediction 144 of the second state 170 indicates that a user of the device 100 is likely to transition from a low motion activity to a running activity or to a walking activity, then the device 100 may adjust from using the third spatial margin 136z to using the first spatial margin 136x or the second spatial margin 136y, respectively.

Although the example of FIG. 4 may illustrate three activity types and three spatial margins, other examples are also within the scope of the disclosure. To illustrate, in some implementations, two activity types and two spatial margins may be used, or four (or more) activity types and four (or more) spatial margins may be used. Further, in some implementations, multiple types of activities may be mapped to one spatial margin, or multiple spatial margins may be mapped to one type of activity. As an illustrative example, a jogging activity and a sprinting activity may be mapped to the same spatial margin or to different spatial margins. As an additional example, in some implementations, the same spatial margin may be assigned to different activities, such as if a jumping activity and a running activity are mapped to the same spatial margin. Other examples are also within the scope of the disclosure.

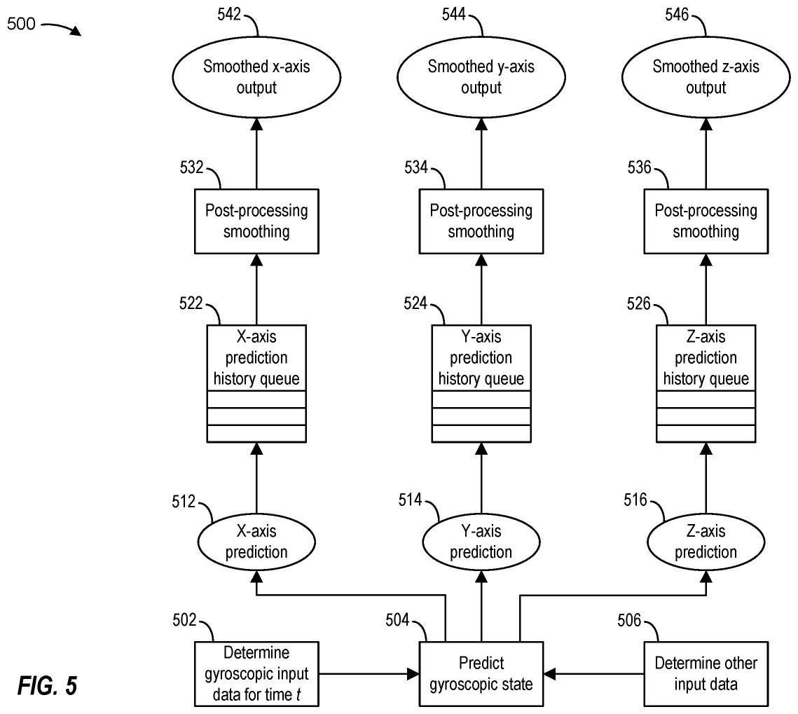

FIG. 5 illustrates an example of a process 500 that supports predictive EIS according to one or more aspects. In some examples, the process 500 may be performed by the device 100 of FIG. 1. For example, the ISP 112 may perform the process 500 (e.g., using the ML engine 142).

The process 500 may include determining gyroscopic input data for a time t, at 502, and may further include determining other input data, at 506. In some examples, the gyroscopic input data and the other input data may be included in the sensor data 166. To further illustrate, the gyroscopic input data may include the gyroscopic axes values 352 of FIG. 3, and the other input data may include any of the focal length value 354, the OIS information 356, or the other data 358 of FIG. 3. In some examples, the gyroscopic input data may represent the first state 168 of FIG. 1.

The process 500 may further include predicting a gyroscopic state, at 504. In some examples predicting the gyroscopic state may include generating one or more of an x-axis prediction 512, a y-axis prediction 514, or a z-axis prediction 516.

The process 500 may further include storing the x-axis prediction 512 to an x-axis prediction history queue 522, storing the y-axis prediction 514 to a y-axis prediction history queue 524, and storing the z-axis prediction 516 to a z-axis prediction history queue 526. In some examples, one or more of the x-axis prediction history queue 522, the y-axis prediction history queue 524, or the z-axis prediction history queue 526 may include a first-in, first-out (FIFO) buffer. In some such examples, storing the x-axis prediction 512 to the x-axis prediction history queue 522 may evict another x-axis prediction, storing the y-axis prediction 514 to the y-axis prediction history queue 524 may evict another y-axis prediction, and storing the z-axis prediction 516 to the z-axis prediction history queue 526 may evict another z-axis prediction.

The process 500 may further include performing post-processing smoothing 532 based on x-axis predictions stored at the x-axis prediction history queue 522 to generate a smoothed x-axis output 542. For example, performing the post-processing smoothing 532 may include determining a weighted statistical measure (e.g., a moving average, a weighted average, a moving weighted average, or another weighted statistical measure) associated with the x-axis predictions stored at the x-axis prediction history queue 522 to generate the smoothed x-axis output 542.

The process 500 may further include performing post-processing smoothing 534 based on y-axis predictions stored at the y-axis prediction history queue 524 to generate a smoothed y-axis output 544. For example, performing the post-processing smoothing 534 may include determining a weighted statistical measure (e.g., a moving average, a weighted average, a moving weighted average, or another weighted statistical measure) associated with the y-axis predictions stored at the y-axis prediction history queue 524 to generate the smoothed y-axis output 544.

The process 500 may further include performing post-processing smoothing 536 based on z-axis predictions stored at the z-axis prediction history queue 526 to generate a smoothed z-axis output 546. For example, performing the post-processing smoothing 536 may include determining a weighted statistical measure (e.g., a moving average, a weighted average, a moving weighted average, or another weighted statistical measure) associated with the z-axis predictions stored at the z-axis prediction history queue 526 to generate the smoothed z-axis output 546.

In some examples, the smoothed x-axis output 542, the smoothed y-axis output 544, and the smoothed z-axis output 546 may correspond to a prediction of a future state of the at least one sensor of the one or more sensors 162 of FIG. 1, such as the gyroscopic sensor 164. To illustrate, the smoothed x-axis output 542, the smoothed y-axis output 544, and the smoothed z-axis output 546 may correspond to the prediction 144 of the second state 170 of the gyroscopic sensor 164.

The example of FIG. 5 illustrates that historical prediction values may be used to predict a subsequent state of the one or more sensors 162 of FIG. 1. To illustrate, in some implementations, the prediction 144 of the second state 170 may correspond to an average of historical prediction values associated with the gyroscopic sensor 164. The historical prediction values may be accessed from one or more prediction history queues, such as one or more of the x-axis prediction history queue 522, the y-axis prediction history queue 524, or the z-axis prediction history queue 526. To further illustrate, the prediction 144 of the second state 170 may correspond to or may be based on one or more of a weighted statistical measure (e.g., an average) of the x-axis predictions stored at the x-axis prediction history queue 522, a weighted statistical measure (e.g., an average) of the y-axis predictions stored at the y-axis prediction history queue 524, or a weighted statistical measure of (e.g., an average) of the z-axis predictions stored at the z-axis prediction history queue 526.

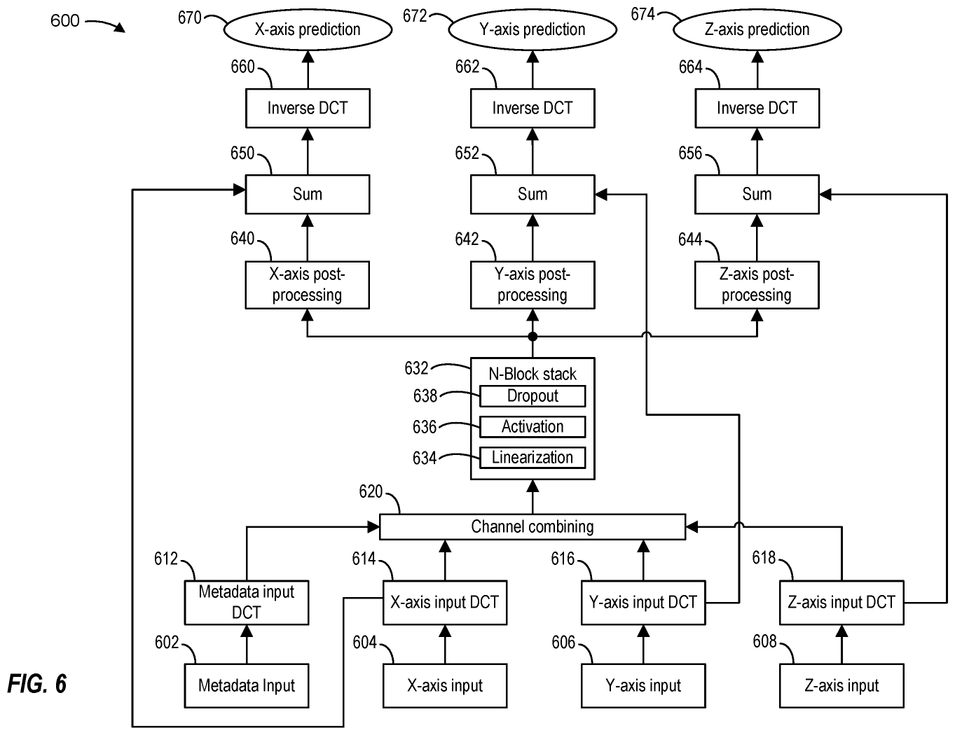

FIG. 6 illustrates an example of a process 600 that supports predictive EIS according to one or more aspects. In some examples, the process 600 may be performed by the device 100 of FIG. 1. For example, the ISP 112 may perform the process 600 (e.g., using the ML engine 142).

The process 600 may include receiving metadata input, at 602, receiving x-axis input, at 604, receiving y-axis input, at 606, and receiving z-axis input, at 608. In some examples, the x-axis input, the y-axis input, and the z-axis input may be received from the gyroscopic sensor 164. To illustrate, the x-axis input, the y-axis input, and the z-axis input may be included in the sensor data 166 or the gyroscopic axes values 352. The x-axis input, the y-axis input, and the z-axis input may represent the first state 168. In some examples, the metadata may include one or more of the focal length value 354, the OIS information 356, or the other data 358.

The process 600 may further include performing processing of the metadata input, at 612, performing processing of the x-axis input, at 614, performing processing of the y-axis input, at 616, and performing processing of the z-axis input, at 618. In some examples, the processing may include performing a discrete cosine transform (DCT) of the metadata input, performing a DCT of the x-axis input, performing a DCT of the y-axis input, and performing a DCT of the z-axis input. Depending on the implementation, DCT operations may be performed on a per-channel basis (e.g., as illustrated in the example of FIG. 6) or for a combination of inputs. For example, in some implementations, the x-axis input, the y-axis input, and the z-axis input may be combined to produce a combined result, and a DCT may be performed based on the combined result.

The process 600 may further include performing channel combining, at 620. For example, the channel combining may include generating data representing a combination of the metadata input, the x-axis input, the y-axis input, and the z-axis input. In some examples, the channel combining may include performing one or more of a convolution operation, a summation operation, or a linear transformation operation to generate the data representing the combination of the metadata input, the x-axis input, the y-axis input, and the z-axis input.

The process 600 may further include performing operations associated with an N-block stack based on the combined channels, at 632. In some examples, the operations may include one or more of linearization 634, activation 636, or a dropout operation 638. In some examples, the process 600 may include performing x-axis post-processing to generate processed x-axis data, at 640, performing y-axis post-processing to generate processed y-axis data, at 642, and performing z-axis post-processing to generate processed z-axis data, at 644.

The process 600 may further include summing the processed x-axis data and the processed x-axis input to generate a first sum, at 650, summing the processed y-axis data and the processed y-axis input to generate a second sum, at 662, and summing the processed z-axis data and the processed z-axis input to generate a third sum, at 664. The process 600 may further include performing an inverse DCT of the first sum, at 660, to generate an x-axis prediction 670, performing an inverse DCT of the second sum, at 662, to generate a y-axis prediction 672, and performing an inverse DCT of the third sum, at 664, to generate a z-axis prediction 674. Depending on the implementation, inverse DCT operations may be performed on a per-channel basis (e.g., as illustrated in the example of FIG. 6) or for a combination of inputs. For example, in some implementations, the first sum, the second sum, and the third sum may be combined to generate a combined result, and an inverse DCT may be performed based on the combined result.

In some examples, the x-axis prediction 670 may correspond to the x-axis prediction 512, the y-axis prediction 672 may correspond to the y-axis prediction 514, and the z-axis prediction 674 may correspond to the z-axis prediction 516 of FIG. 5. In some examples, the x-axis prediction 670, the y-axis prediction 672, and the z-axis prediction 674 may represent the second state 170. In some examples, determining the prediction 144 may include generating the x-axis prediction 670, the y-axis prediction 672, and the z-axis prediction 674.

To further illustrate, determining the prediction 144 of the second state 170 may include performing (e.g., at 612, 614, 616, and 618) a plurality of DCT operations associated with multiple data channels of data (e.g., one or more of the metadata input 602, the x-axis input 604, the y-axis input 606, or the z-axis input 608) to generate multiple transformed data channels. Determining the prediction 144 may further include performing (e.g., at 620) a channel combining operation associated with the transformed data to generate data representing a combination of the multiple transformed data channels. Determining the prediction 144 may further include performing one or more of the linearization 634, the activation 636, the dropout operation 638, or post-processing (e.g., at 640, 642, and 644) based on the combination of the multiple transformed data channels to generate a plurality of values. Determining the prediction 144 may further include performing a plurality of summation operations (e.g., at 650, 652, and 654) associated with at least a subset of the multiple data channels based on the plurality of values and the second data to generate a plurality of summation values. For example, the subset may include data channels associated with the x-axis input, the y-axis input, and the z-axis input and may exclude a data channel associated with the metadata input. Determining the prediction 144 may further include performing (e.g., at 660, 662, and 664) a plurality of inverse DCT operations associated with the plurality of summation values to generate a plurality of predicted values (e.g., the x-axis prediction 670, the y-axis prediction 672, and the z-axis prediction 674) associated with the prediction 144 of the second state 170.

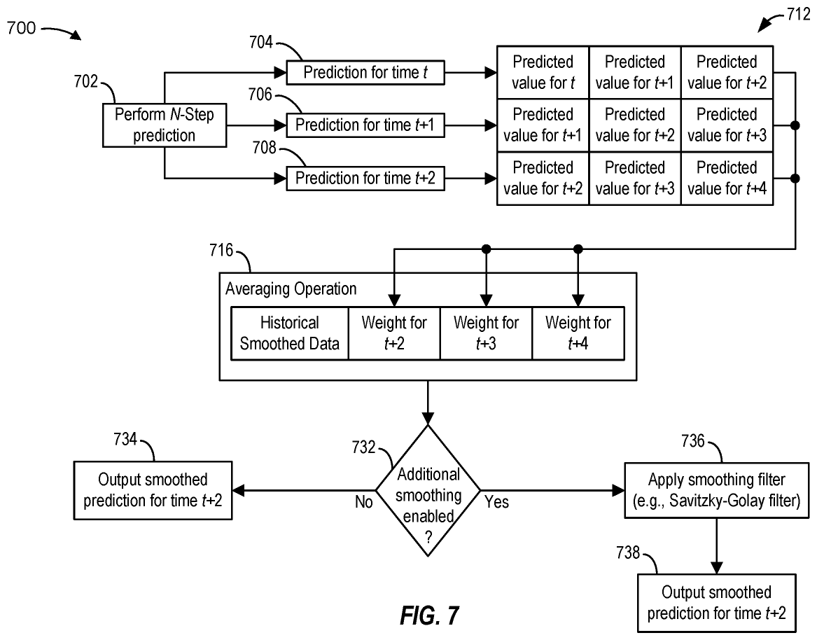

FIG. 7 illustrates an example of a process 700 that supports predictive EIS according to one or more aspects. In some examples, the process 700 may be performed by the device 100 of FIG. 1. For example, the ISP 112 may perform the process 700 (e.g., using the ML engine 142). In some examples, the process 700 may be performed to implement one or more of the post-processing operations described with reference to FIG. 6 (e.g., at 640, 642, and 644).

The process 700 may include performing an N-step prediction, where N indicates a positive integer. To illustrate, the example of FIG. 7 may correspond to N=2. For example, the N-step prediction may be performed for time t as well as for time t=1 (e.g., a first time step following time t) and for time t=2 (e.g., a second time step following time t). In some examples, the ML engine 142 may be trained to perform the N-step prediction, such as by training the ML engine 142 with labeled training data from the gyroscopic sensor 164, with unlabeled training data from the gyroscopic sensor 164, or both. Performing the N-step prediction may include generating a predicted value 704 associated with time t, generating a predicted value 706 associated with time t+1, and generating a predicted value 708 associated with time t+2.

Each of the predicted values 704, 706, and 708 may represent a state associated with a sensor, such as the gyroscopic sensor 164. To illustrate, in some examples, each of the predicted values 704, 706, and 708 may correspond to a set of axes values associated with the gyroscopic sensor 164, such as a set of values including a x-axis value, a y-axis value, and a z-axis value.

The process 700 may further include generating, for each of the predicted values 704, 706, and 708, N additional predictions to generate a set of predicted values 712. For example, if N=2, then two additional predicted values may be generated for each of the predicted values 704, 706, and 708. To illustrate, in addition to the predicted value 704 for time t, a predicted value for time t+1 and a predicted value for time t+2 may be generated based on the predicted value 704 for time t. As another example, in addition to the predicted value 706 for time t+1, a predicted value for time t+2 and a predicted value for time t+3 may be generated based on the predicted value 706 for time t+1. As an additional example, in addition to the predicted value 708 for time t+2, a predicted value for time t+3 and a predicted value for time t+4 may be generated based on the predicted value 708 for time t+2. Accordingly, in the example of FIG. 7, the set of predicted values 712 may include nine predicted values. In other examples, the set of predicted values 712 may include a different quantity of predicted values.

The process 700 may further include performing an averaging operation based on the set of predicted values 712, at 716. For example, the averaging operation may include generating a weighted statistical measure for time t+2, generating a weighted statistical measure for time t+3, and generating a weighted statistical measure for time t+4. In some examples, each such weighted statistical measure may correspond to a weighted average, a moving average, a moving weighted average, or another weighted statistical measure. Further, in some examples, the averaging operation may be performed based at least in part on historical smoothed data.

The process 700 may further include determining whether to apply additional smoothing (e.g., via a smoothing filter) to the results of the averaging operation, at 732. To illustrate, in some examples, additional smoothing may be enabled or disabled dynamically during operation of the device 100 of FIG. 1. As an illustrative example, additional smoothing may be performed based on an activity associated with a user, such as if additional smoothing is enabled during more dynamic motion (such as running) and disabled for less dynamic motion (such as walking). In such examples, additional smoothing may be enabled in connection with use of the first spatial margin 136x and may be disabled in connection with use of the third spatial margin 136z. Other examples are also within the scope of the disclosure.

In some examples, if additional smoothing is disabled, the process 700 may further include outputting a smoothed prediction for time t+2 based on the results of the averaging operation, at 734. In some examples, the smoothed prediction for time t+2 may include x-axis, y-axis, and z-axis values associated with the gyroscopic sensor 164. In some examples, the prediction for time t+2 may be included in the x-axis data, the z-axis data, and the z-axis data, at 640, 642, and 644 of FIG. 6.

In some other examples, if additional smoothing is enabled, the process 700 may further include applying a smoothing filter to the results of the averaging operation, at 736. An example of a smoothing filter may include a Savitzky-Golay filter or another filter. The process 700 may further include outputting a prediction for time t+2 based on an output of the smoothing filter, at 738. In some examples, the smoothed prediction for time t+2 may include x-axis, y-axis, and z-axis values associated with the gyroscopic sensor 164. In some examples, the prediction for time t+2 may be included in the x-axis data, the z-axis data, and the z-axis data, at 640, 642, and 644 of FIG. 6.

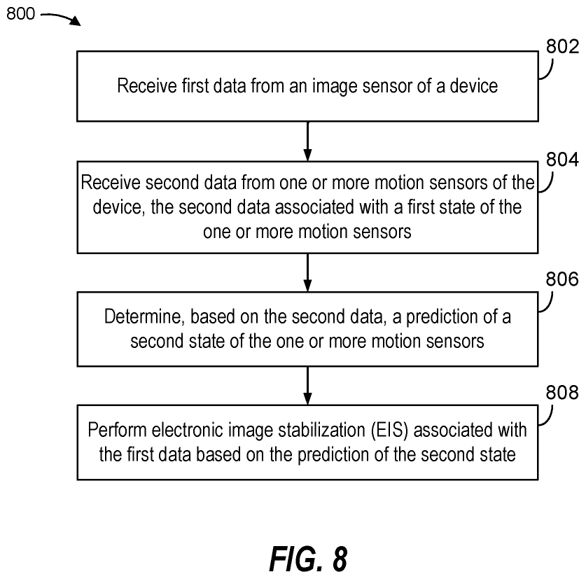

FIG. 8 illustrates an example of a process 800 that supports predictive EIS according to one or more aspects. In some examples, the process 800 may be performed by a device, such as the device 100 of FIG. 1. In some examples, the ISP 112 may perform the process 800.

The process 800 includes receiving first data from an image sensor of the device, at 802. For example, the device 100 may receive the video data 110 from one or more of the first image sensor 101 or the second image sensor 102.

The process 800 further includes receiving second data from one or more motion sensors of the device, at 804. The second data is associated with a first state of the one or more motion sensors. For example, the device 100 may receive the sensor data 166 from the one or more sensors 162, and the sensor data 166 may be associated with the first state 168 of the one or more sensors 162.

The process 800 further includes determining, based on the second data, a prediction of a second state of the one or more motion sensors, at 806. For example, the device 100 may determine, based on the sensor data 166, a prediction 144 of the second state 170 of the one or more sensors 162.

The process 800 further includes performing electronic image stabilization (EIS) associated with the first data based on the prediction of the second state, at 808. For example, the device 100 may perform EIS associated with the video data 110 to generate the stabilized video data 138.

One or more features described herein may improve performance of a device, such as the device 100 of FIG. 1. For example, by selecting among the spatial margins 136 based on estimated user activity, the device 100 may predictively increase spatial margin area if activities associated with increased shake or jitter (such as running) are predicted to occur. In some other examples, the device 100 may decrease spatial margin area if activities associated with less shake or jitter (such as sitting or standing) are predicted to occur. As a result, video content (such as the stabilized video data 138) may benefit from increased stabilization during some activities while reducing an amount of unused video data during other activities, reducing power consumption and device resource utilization (e.g., utilization of processing resources, memory resources, and bandwidth).

To further illustrate, in some examples, one or more features described herein may reduce power consumption and may also reduce an amount of data transferred among device components, such as components of the ISP 112, the processor 104, the memory 106, one or more other components, or a combination thereof. For example, by estimating a type of motion or activity, a margin area associated with EIS may be determined sooner as compared to other techniques (such as a non-predictive technique), which may be associated with increased lag. As a result, one or more portions of the video data 110 may be deleted (e.g., by invalidating, erasing, or overwriting such portions) sooner as compared to other techniques, such as a non-predictive technique. As a non-limiting example, in some implementations, such portions may be deleted at a front end stage of the ISP 112 (e.g., at the second IFE stage 308) instead of at a subsequent stage of the ISP, such as one or more of the EVA 312, the first IPE 316, or the second IPE 320. Accordingly, power consumption associated with transfer and storage of such video data may be reduced while also reducing use of device resources, such as processing resources, storage resources, and bandwidth of the device 100.

In a first aspect, an apparatus includes a processing system including one or more processors and one or more memories coupled to the one or more processors. The processing system is configured to receive first data from an image sensor and to receive second data from one or more motion sensors. The second data is associated with a first state of the one or more motion sensors. The processing system is further configured to determine, based on the second data, a prediction of a second state of the one or more motion sensors and to perform electronic image stabilization (EIS) associated with the first data based on the prediction of the second state.

In a second aspect, in combination with the first aspect, the first data includes first image data associated with a first time and further includes second image data associated with a second time after the first time. The processing system is further configured to process the first image data according to a first spatial margin and according to the first state of the one or more motion sensors and to process the second image data according to a second spatial margin different than the first spatial margin and according to the prediction of the second state.

In a third aspect, in combination with one or more of the first aspect or the second aspect, the processing system is further configured to select a spatial margin associated with the EIS based at least in part on the prediction of the second state.

In a fourth aspect, in combination with one or more of the first aspect through the third aspect, the second state is associated with a particular motion classification of a plurality of motion classifications respectively associated with a plurality of spatial margins, and the processing system is further configured to select the spatial margin from the plurality of spatial margins based on the prediction of the second state.

In a fifth aspect, in combination with one or more of the first aspect through the fourth aspect, the one or more motion sensors include a gyroscopic sensor, the first state indicates a first position of the gyroscopic sensor, and the second state indicates a second position of the gyroscopic sensor.

In a sixth aspect, in combination with one or more of the first aspect through the fifth aspect, the prediction of the second state corresponds to a weighted statistical measure of historical prediction values associated with the one or more motion sensors, and the processing system is further configured to access the historical prediction values from one or more prediction history queues.

In a seventh aspect, in combination with one or more of the first aspect through the sixth aspect, the processing system is further configured to execute a machine learning (ML) engine to determine the prediction of the second state

In an eighth aspect, a method of operation of a device includes receiving first data from an image sensor of the device and receiving second data from one or more motion sensors of the device. The second data is associated with a first state of the one or more motion sensors. The method further includes determining, based on the second data, a prediction of a second state of the one or more motion sensors and performing electronic image stabilization (EIS) associated with the first data based on the prediction of the second state.

In a ninth aspect, in combination with the eighth aspect, the first data includes first image data captured by the image sensor at a first time and further includes second image data captured by the image sensor at a second time after the first time. The method further includes processing the first image data according to a first spatial margin and according to the first state of the one or more motion sensors and processing the second image data according to a second spatial margin different than the first spatial margin and according to the prediction of the second state.

In a tenth aspect, in combination with one or more of the eighth aspect through the ninth aspect, performing the EIS includes selecting a spatial margin associated with the EIS based at least in part on the prediction of the second state.

In an eleventh aspect, in combination with one or more of the eighth aspect through the tenth aspect, the second state is associated with a particular motion classification of a plurality of motion classifications respectively associated with a plurality of spatial margins, and the spatial margin is selected from the plurality of spatial margins based on the prediction of the second state.

In a twelfth aspect, in combination with one or more of the eighth aspect through the eleventh aspect, the one or more motion sensors include a gyroscopic sensor, wherein the first state indicates a first position of the gyroscopic sensor, and the second state indicates a second position of the gyroscopic sensor.

In a thirteenth aspect, in combination with one or more of the eighth aspect through the twelfth aspect, the prediction of the second state corresponds to a weighted statistical measure of historical prediction values associated with the one or more motion sensors. The method further includes accessing the historical prediction values from one or more prediction history queues.

In a fourteenth aspect, in combination with one or more of the eighth aspect through the thirteenth aspect, the prediction of the second state is determined by a machine learning (ML) engine of the device.

In a fifteenth aspect, in combination with one or more of the eighth aspect through the fourteenth aspect, determining the prediction of the second state includes performing a discrete cosine transform (DCT) associated with multiple data channels of the second data to generate multiple transformed data channels and further includes performing a channel combining operation associated with the transformed data to generate data representing a combination of the multiple transformed data channels.

In a sixteenth aspect, in combination with one or more of the eighth aspect through the fifteenth aspect, determining the prediction of the second state further includes performing one or more of linearization, activation, a dropout operation, or post-processing based on the combination of the multiple transformed data channels to generate a plurality of values and further includes performing a plurality of summation operations associated with at least a subset of the multiple data channels based on the plurality of values and the second data to generate a plurality of summation values.

In a seventeenth aspect, in combination with one or more of the eighth aspect through the sixteenth aspect, determining the prediction of the second state further includes performing a plurality of inverse DCT operations associated with the plurality of summation values to generate a plurality of predicted values associated with the prediction of the second state.

In an eighteenth aspect, a non-transitory computer-readable medium stores instructions executable by a processor to perform operations. The operations include receiving first data from an image sensor and receiving second data from one or more motion sensors. The second data is associated with a first state of the one or more motion sensors. The operations further include determining, based on the second data, a prediction of a second state of the one or more motion sensors and performing electronic image stabilization (EIS) associated with the first data based on the prediction of the second state.

In a nineteenth aspect, in combination with the eighteenth aspect, the first data includes first image data captured by the image sensor at a first time and further includes second image data captured by the image sensor at a second time after the first time. The instructions are further executable by the processor to process the first image data according to a first spatial margin and according to the first state of the one or more motion sensors and to process the second image data according to a second spatial margin different than the first spatial margin and according to the prediction of the second state.

In a twentieth aspect, in combination with one or more of the eighteenth aspect through the nineteenth aspect, the second state is associated with a particular motion classification of a plurality of motion classifications respectively associated with a plurality of spatial margins, and the instructions are further executable by the processor to select a spatial margin for the EIS from among the plurality of spatial margins in accordance with the particular motion classification.

In the figures, a single block may be described as performing a function or functions. The function or functions performed by that block may be performed in a single component or across multiple components, and/or may be performed using hardware, software, or a combination of hardware and software. To illustrate, one or more components, blocks, modules, circuits, and operations may be described generally in terms of their functionality. Whether such functionality is implemented as hardware or software may depend upon the particular application and design of the overall system. Skilled artisans may implement the described functionality in varying ways for each particular application, but such implementation decisions should not be interpreted as causing a departure from the scope of the disclosure.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein may include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via processor circuitry, via executable instructions, or combinations thereof.

A hardware and data processing apparatus used to implement the various illustrative logics, logical blocks, modules and circuits described in connection with one or more features disclosed herein may be implemented or performed with a single- or multi-chip processor, a digital signal processor (DSP), an application specific integrated circuit (ASIC), a field programmable gate array (FPGA) or other programmable logic device, discrete gate or transistor logic, discrete hardware components, or any combination thereof. A processor may be a microprocessor, controller, microcontroller, state machine, or other processor. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

If implemented in software, one or more functions may be stored on or transmitted over as one or more instructions or code on a computer-readable medium. The operations of a method or process disclosed herein may be implemented in a processor-executable software module which may reside on a computer-readable medium. Computer-readable media includes computer storage media. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or process may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus comprising:
a processing system including one or more processors and one or more memories coupled to the one or more processors, the processing system configured to:
receive first data from an image sensor;
receive second data from one or more motion sensors, the second data associated with a first state of the one or more motion sensors;
determine, based on the second data, a prediction of a second state of the one or more motion sensors; and
perform electronic image stabilization (EIS) associated with the first data based on the prediction of the second state.

2. The apparatus of claim 1, wherein the first data includes first image data associated with a first time and further includes second image data associated with a second time after the first time, and wherein the processing system is further configured to:
process the first image data according to a first spatial margin and according to the first state of the one or more motion sensors; and
process the second image data according to a second spatial margin different than the first spatial margin and according to the prediction of the second state.

3. The apparatus of claim 1, wherein the processing system is further configured to select a spatial margin associated with the EIS based at least in part on the prediction of the second state.

4. The apparatus of claim 3, wherein the second state is associated with a particular motion classification of a plurality of motion classifications respectively associated with a plurality of spatial margins, and wherein the processing system is further configured to select the spatial margin from the plurality of spatial margins based on the prediction of the second state.

5. The apparatus of claim 1, wherein the one or more motion sensors include a gyroscopic sensor, wherein the first state indicates a first position of the gyroscopic sensor, and wherein the second state indicates a second position of the gyroscopic sensor.

6. The apparatus of claim 1, wherein the prediction of the second state corresponds to a weighted statistical measure of historical prediction values associated with the one or more motion sensors, and wherein the processing system is further configured to access the historical prediction values from one or more prediction history queues.

7. The apparatus of claim 1, wherein the processing system is further configured to execute a machine learning (ML) engine to determine the prediction of the second state.

8. A method of operation of a device, the method comprising:
receiving first data from an image sensor of the device;
receiving second data from one or more motion sensors of the device, the second data associated with a first state of the one or more motion sensors;
determining, based on the second data, a prediction of a second state of the one or more motion sensors; and
performing electronic image stabilization (EIS) associated with the first data based on the prediction of the second state.

9. The method of claim 8, wherein the first data includes first image data captured by the image sensor at a first time and further includes second image data captured by the image sensor at a second time after the first time, and further comprising:
processing the first image data according to a first spatial margin and according to the first state of the one or more motion sensors; and
processing the second image data according to a second spatial margin different than the first spatial margin and according to the prediction of the second state.

10. The method of claim 8, wherein performing the EIS includes selecting a spatial margin associated with the EIS based at least in part on the prediction of the second state.

11. The method of claim 10, wherein the second state is associated with a particular motion classification of a plurality of motion classifications respectively associated with a plurality of spatial margins, and wherein the spatial margin is selected from the plurality of spatial margins based on the prediction of the second state.

12. The method of claim 8, wherein the one or more motion sensors include a gyroscopic sensor, wherein the first state indicates a first position of the gyroscopic sensor, and wherein the second state indicates a second position of the gyroscopic sensor.

13. The method of claim 8, wherein the prediction of the second state corresponds to a weighted statistical measure of historical prediction values associated with the one or more motion sensors, and further comprising accessing the historical prediction values from one or more prediction history queues.

14. The method of claim 8, wherein the prediction of the second state is determined by a machine learning (ML) engine of the device.

15. The method of claim 8, wherein determining the prediction of the second state includes:
performing a discrete cosine transform (DCT) associated with multiple data channels of the second data to generate multiple transformed data channels; and
performing a channel combining operation associated with the transformed data to generate data representing a combination of the multiple transformed data channels.

16. The method of claim 15, wherein determining the prediction of the second state further includes:
performing one or more of linearization, activation, a dropout operation, or post-processing based on the combination of the multiple transformed data channels to generate a plurality of values; and
performing a plurality of summation operations associated with at least a subset of the multiple data channels based on the plurality of values and the second data to generate a plurality of summation values.

17. The method of claim 16, wherein determining the prediction of the second state further includes performing a plurality of inverse DCT operations associated with the plurality of summation values to generate a plurality of predicted values associated with the prediction of the second state.

18. A non-transitory computer-readable medium storing instructions executable by a processor to perform operations, the operations comprising:
receiving first data from an image sensor;
receiving second data from one or more motion sensors, the second data associated with a first state of the one or more motion sensors;
determining, based on the second data, a prediction of a second state of the one or more motion sensors; and
performing electronic image stabilization (EIS) associated with the first data based on the prediction of the second state.

19. The non-transitory computer-readable medium of claim 18, wherein the first data includes first image data captured by the image sensor at a first time and further includes second image data captured by the image sensor at a second time after the first time, and wherein the instructions are further executable by the processor to:
processing the first image data according to a first spatial margin and according to the first state of the one or more motion sensors; and
processing the second image data according to a second spatial margin different than the first spatial margin and according to the prediction of the second state.

20. The non-transitory computer-readable medium of claim 18, wherein the second state is associated with a particular motion classification of a plurality of motion classifications respectively associated with a plurality of spatial margins, and wherein the instructions are further executable by the processor to select a spatial margin for the EIS from among the plurality of spatial margins in accordance with the particular motion classification.
